(19) United States
(12) Patent Application Publication
(10) Pub. No.: US 2022/0214692 A1
(43) Pub. Date: Jul. 7, 2022

(54) VIsion-Based Robot Navigation By Coupling Deep Reinforcement Learning And A Path Planning Algorithm

(71) Applicant: Ford Global Technologies, LLC, Dearborn, MI (US)

(72) Inventors: Punarjay Chakravarty, Campbell, CA (US); Kaushik Balakrishnan, Cupertino, CA (US); Shubham Shrivastava, Sunnyvale, CA (US)

(73) Assignee: Ford Global Technologies, LLC, Dearborn, MI (US)

(21) Appl. No.: 17/141,433

(22) Filed: Jan. 5, 2021

(51) Int. Cl. G05D 1/02; B25J 9/16

(52) U.S. Cl. CPC G05D 1/0221; G05D 1/0219; G05D 1/0214; G05D 2201/0216; B25J 9/1664; B25J 9/163; G05D 1/0251

(57) ABSTRACT

Present embodiments use deep reinforcement learning (DRL) algorithms and use one or more path planning approaches to create a path using a deep learning approach using a reinforcement learning algorithm, trained using traditional learning algorithms such as A-Star. The reinforcement learning algorithm takes in a forward-facing camera operative as part of a computer vision system for a robot, and utilizes training the algorithm to train the robot to traverse from point A to point B in an operating environment using a sequence of waypoints as a breadcrumb trail. The system trains the robot to learn the path section by section by the waypoints, which prevents requiring the robot to solve the entire path. At test/deploy time, A-star is not used, and the robot navigates the entire start to goal path without any intermediate waypoints

### BACKGROUND

Robot navigation is a challenging problem in many environments as it involves the confluence of several different sub-problems such as mapping, localization, path planning, dynamic & static obstacle avoidance and control. Furthermore, a high-resolution map may not always be available, or a map may be available but is of low-resolution to the point that it is only partially usable. For instance, a low-resolution map may be usable to identify local points of interest to navigate to a final goal, but may not be trustworthy for avoiding obstacles. Collisions with obstacles are obviously undesired and a robust navigation policy must take all these factors into account.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example computing environment in which techniques and structures for providing the systems and methods disclosed herein may be implemented.

FIG. 2 illustrates an example room environment used to train a deep reinforcement learning (DRL) algorithm in accordance with the present disclosure.

FIG. 3 depicts a twin variational autoencoder (VAE) for learning visual embeddings in accordance with the present disclosure.

FIG. 4 depicts a flow diagram for generating an embedding using the VAE of FIG. 3 in accordance with the present disclosure.

FIG. 5 illustrates an example Deep Reinforcement Learning (DRL) setup in accordance with the present disclosure.

FIG. 6 is a graph illustrating a decrease in training times for learning a navigation pathway using the system of FIG. 1 in accordance with the present disclosure.

FIG. 7 depicts a demonstration of quality of paths followed using an algorithm trained using the setup of FIG. 5 in accordance with the present disclosure.

FIGS. 8A-8H depict demonstrations of test time paths followed while training the robot of FIG. 1 in accordance with the present disclosure.

FIG. 9 depicts a flow diagram of an example method for controlling a vehicle in accordance with the present disclosure.

### DETAILED DESCRIPTION

### Overview

The systems and methods disclosed herein are configured and/or programmed to utilize curriculum-based training approaches to train Deep Reinforcement Learning (DRL) agents to navigate indoor environments. A high-level path planning algorithm such as A-Star is used to assist the training of a low-level policy learned using DRL. Once the DRL policy is trained, the robot uses only the current image from its red-green-blue (RGB) camera to successfully find its way to the goal.

Present embodiments use reinforcement learning algorithms and use one or more path planning approaches to create a path using a deep learning approach using reinforcement learning algorithms, trained using traditional learning algorithms.

According to one or more embodiments, a RGB and depth cameras are utilized to navigate map-free indoor environments. Given random start and target positions in an indoor environment, the robot is tasked to navigate from the start to target position without colliding with obstacles.

According to one or more embodiments, a pre-trained perception pipeline (a twin Variational Auto-Encoder or VAE) learns a compact visual embedding at each position in the environment in simulation.

Aspects of the present disclosure may use A-Star, a traditional path-planning algorithm (or similar algorithm) to increase the speed of the training process.

According to one or more embodiments, a DRL policy is curriculum-trained using a sequentially increasing spacing of A-Star waypoints between the start and goal locations (waypoint spacing increases as training progresses), representing increasing difficulty of the navigation task.

Aspects of the present disclosure may provide a robust method for speeding up the training of the DRL based algorithm. In addition, aspects of the present disclosure may improve the performance of the DRL-based navigation algorithm.

### Illustrative Embodiments

The disclosure will be described more fully hereinafter with reference to the accompanying drawings, in which example embodiments of the disclosure are shown, and not intended to be limiting.

Traditionally, robots have used routing/path planning algorithms like A-Star and RRT for navigating through spaces using learning-based approaches, but these only work when a map is given, and is of sufficiently high-resolution, which may not always be the case. In addition, there might be un-mapped objects like moved furniture, or dynamic objects like a person in the robot's vicinity, that are dealt with local path planners that depend on on-board sensing (visual &/or LIDAR) for in-situ decisions and local paths in addition to the global path decided by A-Star (also called A*).

Recently, inexpensive and effective vision and depth sensors (like the Intel® RealSense® sensor) have assisted systems to obtain RGB scans of operational environments. Such sensors are cost-effective and easy to use for indoor mobile robots.

Simultaneously, research and development of modern Deep Reinforcement Learning (DRL) enables robot control policies to be learnt through a data-driven approach. Using recent methods, robots are set free in simulated environments, and DRL is used to learn a control policy that maximizes the expected future reward with massive amounts of simulation data.

However, the amount of data, time and computational resources required to train these DRL algorithms is often prohibitive. For example, experiments conducted by us and the research community have shown that such a DRL path planner that uses RGB and depth data from one robot in one simulated indoor environment takes 240 GPU-hours (approximately 10 days) to learn on a desktop computer.

As robotics are increasingly used in last-mile delivery and for factory-floor automation, the ability to train such navigation policies through a data driven approach in simulation will become crucial. Self-driving delivery platforms may curb the high cost of last-mile and last 100-meter delivery of goods. Robot control systems configured to perform these tasks require path plan training before deployment in the field.

Embodiments of the present disclosure describe methods to combine traditional perception and path planning algorithms with DRL to improve the quality of the learnt path planning policies and decrease the time taken to train it. Experimental results are presented that demonstrate an algorithm utilizing a pre-trained visual embedding for an environment, and a traditional path-planner such as A-Star (or the like) to train a DRL-based control policy. As demonstrated in the experimental results, the learnt DRL policy trains faster and results in improved robotic navigation in an indoor environment. It should also be appreciated that embodiments described in the present disclosure may also work efficiently for training robots in outdoor environments.

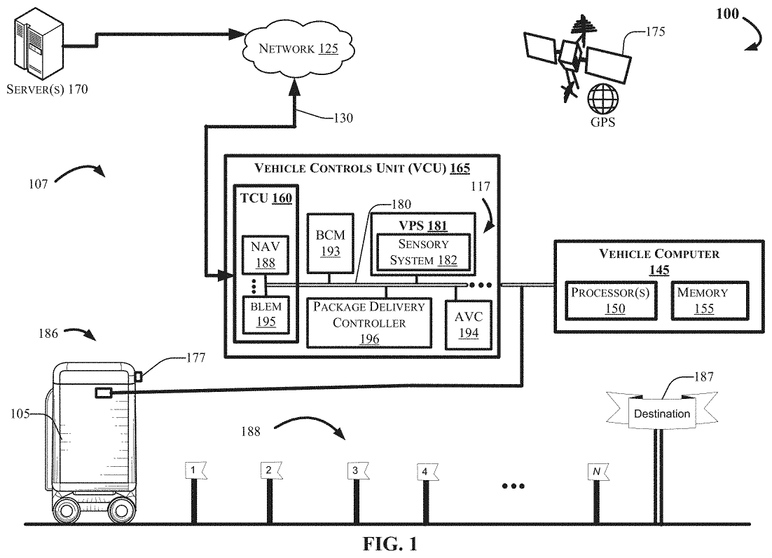

FIG. 1 depicts an example computing environment 100 that can include a robotic vehicle 105. The vehicle 105 can include a robotic vehicle computer 145, and a Vehicle Controls Unit (VCU) 165 that typically includes a plurality of electronic control units (ECUs) 117 disposed in communication with the robotic vehicle computer 145, which may communicate via one or more wireless connection(s) 130, and/or may connect with the vehicle 105 directly using near field communication (NFC) protocols, Bluetooth® protocols, Wi-Fi, Ultra-Wide Band (UWB), and other possible data connection and sharing techniques.

Although not utilized according to embodiments described hereafter the vehicle 105 may also receive and/or be in communication with a Global Positioning System (GPS) 175. The GPS 175 may be a satellite system (as depicted in FIG. 1) such as the global navigation satellite system (GLNSS), Galileo, or navigation or other similar system. In other aspects, the GPS 175 may be a terrestrial-based navigation network, or any other type of positioning technology known in the art of wireless navigation assistance.

The robotic vehicle computer 145 may be or include an electronic vehicle controller, having one or more processor(s) 150 and memory 155. The robotic vehicle computer 145 may, in some example embodiments, be disposed in communication with a mobile device 120 (not shown in FIG. 1), and one or more server(s) 170. The server(s) 170 may be part of a cloud-based computing infrastructure, and may be associated with and/or include a Telematics Service Delivery Network (SDN) that provides digital data services to the vehicle 105 and other vehicles (not shown in FIG. 1) that may be part of a robotic vehicle fleet.

Although illustrated as a four-wheeled delivery robot, the vehicle 105 may take the form of another robot chassis such as, for example, a two-wheeled vehicle, a multi-wheeled vehicle, a track-driven vehicle, etc., and may be configured and/or programmed to include various types of robotic drive systems and powertrains. Methods of training a deep reinforcement learning algorithm using the DRL robot training system 107 may take in RGB and depth images using one or more forward facing camera(s) 177 operative as part of a computer vision system for the robotic vehicle 105, and train the DRL algorithm to go from a starting point 186 to a destination 187 using a sequence of waypoints 188 as a breadcrumb trail. The DRL robot training system 107 may train the robot to learn the path section-by-section along the plurality of waypoints 188, which prevents requiring the robot to solve the entire path to the destination 187.

According to embodiments of the present disclosure, the DRL robot training system 107 may be configured and/or programmed to operate with a vehicle having an autonomous vehicle controller (AVC) 194. Accordingly, the DRL robot training system 107 may provide some aspects of human control to the vehicle 105, when the vehicle is configured as an AV.

In some aspects, the mobile device 120 may communicate with the vehicle 105 through the one or more wireless connection(s) 130, which may be encrypted and established between the mobile device 120 and a Telematics Control Unit (TCU) 160. The mobile device 120 may communicate with the TCU 160 using a wireless transmitter (not shown in FIG. 1) associated with the TCU 160 on the vehicle 105. The transmitter may communicate with the mobile device 120 using a wireless communication network such as, for example, the one or more network(s) 125. The wireless connection(s) 130 are depicted in FIG. 1 as communicating via the one or more network(s) 125, and via one or more wireless connection(s) 130 that can be direct connection(s) between the vehicle 105 and the mobile device 120. The wireless connection(s) 130 may include various low-energy protocols including, for example, Bluetooth®, BLE, or other Near Field Communication (NFC) protocols.

The network(s) 125 illustrate an example of communication infrastructure in which the connected devices discussed in various embodiments of this disclosure may communicate. The network(s) 125 may be and/or include the Internet, a private network, public network or other configuration that operates using any one or more known communication protocols such as, for example, transmission control protocol/Internet protocol (TCP/IP), Bluetooth®, Wi-Fi based on the Institute of Electrical and Electronics Engineers (IEEE) standard 802.11, Ultra-Wide Band (UWB), and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples.

The robotic vehicle computer 145 may be installed in an interior compartment of the vehicle 105 (or elsewhere in the vehicle 105) and operate as a functional part of the DRL robot training system 107, in accordance with the disclosure. The robotic vehicle computer 145 may include one or more processor(s) 150 and a computer-readable memory 155.

The one or more processor(s) 150 may be disposed in communication with one or more memory devices disposed in communication with the respective computing systems (e.g., the memory 155 and/or one or more external databases not shown in FIG. 1). The processor(s) 150 may utilize the memory 155 to store programs in code and/or to store data for performing aspects in accordance with the disclosure. The memory 155 may be a non-transitory computer-readable memory storing a DRL robot training program code. The memory 155 can include any one or a combination of volatile memory elements (e.g., dynamic random access memory (DRAM), synchronous dynamic random access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.).

The VCU 165 may share a power bus (not shown in FIG. 1) with the robotic vehicle computer 145, and may be configured and/or programmed to coordinate the data between vehicle 105 systems, connected servers (e.g., the server(s) 170), and other vehicles such as a transport and mobile warehouse vehicle (not shown in FIG. 1) operating as part of a vehicle fleet. The VCU 165 can include or communicate with any combination of the ECUs 117, such as, for example, a Body Control Module (BCM) 193. The VCU 165 may further include and/or communicate with a Vehicle Perception System (VPS) 181, having connectivity with and/or control of one or more vehicle sensory system(s) 182. In some aspects, the VCU 165 may control operational aspects of the vehicle 105, and implement one or more instruction sets operational as part of the DRL robot training system 107. The VPS 181 may be disposed in communication with a package delivery controller 196.

The VPS 181 may include a LIDAR device, a sonar device, an IR camera, an RGB camera, an inertial measurement unit (IMU), and/or other sensing devices disposed onboard the vehicle, which may be used by the package delivery controller 196 to sense vehicle location, generate a navigation map (not shown in FIG. 1), and navigate to the destination 187. The vehicle 105 may generate the navigation map with or without using a prior high definition map, and may update the map, once created or accessed, with new information encountered during delivery operations.

The TCU 160 can be configured and/or programmed to provide vehicle connectivity to wireless computing systems onboard and offboard the vehicle 105, and may include a Navigation (NAV) receiver 188 for receiving and processing a GPS signal from the GPS 175, a Bluetooth® Low-Energy (BLE) Module (BLEM) 195, a Wi-Fi transceiver, an Ultra-Wide Band (UWB) transceiver, and/or other wireless transceivers (not shown in FIG. 1) that may be configurable for wireless communication between the vehicle 105 and other systems, computers, and modules. The TCU 160 may be disposed in communication with the ECUs 117 by way of a bus 180. In some aspects, the TCU 160 may retrieve data and send data as a node in a CAN bus.

The BLEM 195 may establish wireless communication using Bluetooth® and Bluetooth Low-Energy® communication protocols by broadcasting and/or listening for broadcasts of small advertising packets, and establishing connections with responsive devices that are configured according to embodiments described herein. For example, the BLEM 195 may include Generic Attribute Profile (GATT) device connectivity for client devices that respond to or initiate GATT commands and requests.

The bus 180 may be configured as a Controller Area Network (CAN) bus organized with a multi-master serial bus standard for connecting two or more of the ECUs 117 as nodes using a message-based protocol that can be configured and/or programmed to allow the ECUs 117 to communicate with each other. The bus 180 may be or include a high speed CAN (which may have bit speeds up to 1 Mb/s on CAN, 5 Mb/s on CAN Flexible Data Rate (CAN FD)), and can include a low-speed or fault-tolerant CAN (up to 125 Kbps), which may, in some configurations, use a linear bus configuration. In some aspects, the ECUs 117 may communicate with a host computer (e.g., the robotic vehicle computer 145, the DRL robot training system 107, and/or the server(s) 170, etc.), and may also communicate with one another without the necessity of a host computer such as, for example, a teleoperator terminal 171. The bus 180 may connect the ECUs 117 with the robotic vehicle computer 145 such that the robotic vehicle computer 145 may retrieve information from, send information to, and otherwise interact with the ECUs 117 to perform steps described according to embodiments of the present disclosure. The bus 180 may connect CAN bus nodes (e.g., the ECUs 117) to each other through a two-wire bus, which may be a twisted pair having a nominal characteristic impedance. The bus 180 may also be accomplished using other communication protocol solutions, such as Media Oriented Systems Transport (MOST) or Ethernet. In other aspects, the bus 180 may be a wireless intra-vehicle bus.

The VCU 165 may control various loads directly via the bus 180 communication or implement such control in conjunction with the BCM 193. The ECUs 117 described with respect to the VCU 165 are provided for example purposes only, and are not intended to be limiting or exclusive. Control and/or communication with other control modules not shown in FIG. 1 is possible, and such control is contemplated.

In an example embodiment, the ECUs 117 may control aspects of vehicle operation and communication using inputs from human teleoperators, inputs from the AVC 194, the DRL robot training system 107, and/or via wireless signal inputs received via the wireless connection(s) 130 from other connected devices. The ECUs 117, when configured as nodes in the bus 180, may each include a central processing unit (CPU), a CAN controller, and/or a transceiver (not shown in FIG. 1).

The BCM 193 generally includes integration of sensors, vehicle performance indicators, and variable reactors associated with vehicle systems, and may include processor-based power distribution circuitry that can control functions associated with the vehicle body such as lights, windows, security, door locks and access control, and various comfort controls. The BCM 193 may also operate as a gateway for bus and network interfaces to interact with remote ECUs (not shown in FIG. 1). The BCM 193 may further include robot power management circuitry that can control power distribution from a power supply (not shown in FIG. 1) to vehicle 105 components.

The BCM 193 may coordinate any one or more functions from a wide range of vehicle functionality, including energy management systems, alarms, vehicle immobilizers, driver and rider access authorization systems, and other functionality. In other aspects, the BCM 193 may control auxiliary equipment functionality, and/or be responsible for integration of such functionality.

The computing system architecture of the robotic vehicle computer 145, VCU 165, and/or the DRL robot training system 107 may omit certain computing modules. It should be readily understood that the computing environment depicted in FIG. 1 is an example of a possible implementation according to the present disclosure, and thus, it should not be considered limiting or exclusive.

The sensory systems 182 may provide the sensory data obtained from the sensory system 182 responsive to an internal sensor request message. The sensory data may include information from various sensors where the sensor request message can include the sensor modality with which the respective sensor system(s) are to obtain the sensory data.

The sensory system 182 may include one or more camera sensor(s) 177, which may include thermal cameras, optical cameras, and/or a hybrid camera having optical, thermal, or other sensing capabilities. Thermal and/or infrared (IR) cameras may provide thermal information of objects within a frame of view of the camera(s), including, for example, a heat map figure of a subject in the camera frame. An optical camera may provide RGB and/or black-and-white and depth image data of the target(s) and/or the robot operating environment within the camera frame. The camera sensor(s) 177 may further include static imaging, or provide a series of sampled data (e.g., a camera feed).

The sensory system 182 may further include an inertial measurement unit IMU (not shown in FIG. 1), which may include a gyroscope, an accelerometer, a magnetometer, or other inertial measurement device.

The sensory system 182 may further include one or more lighting systems such as, for example, a flash light source 179, and the camera system 177. The flash light source 179 may include a flash device, similar to those used in photography for producing a flash of artificial light (typically 1/1000 to 1/200 of a second) at a color temperature of about 5500 K to illuminate a scene, and/or capture quickly moving objects or change the quality of light in the operating environment 100. Flash refers either to the flash of light itself or to the electronic flash unit (e.g., the flash light source 179) discharging the light. Flash units are commonly built directly into a camera. Some cameras allow separate flash units to be mounted via a standardized “accessory mount” bracket (a hot shoe).

The package delivery controller 196 may include program code and hardware configured and/or programmed for obtaining images and video feed via the VPS 181, and performing semantic segmentation using IR thermal signatures, RGB images, and combinations of RGB/depth and IR thermal imaging obtained from the sensory system 182. Although depicted as a separate component with respect to the robot vehicle computer 145, it should be appreciated that any one or more of the ECUs 117 may be integrated with and/or include the robot vehicle computer 145.

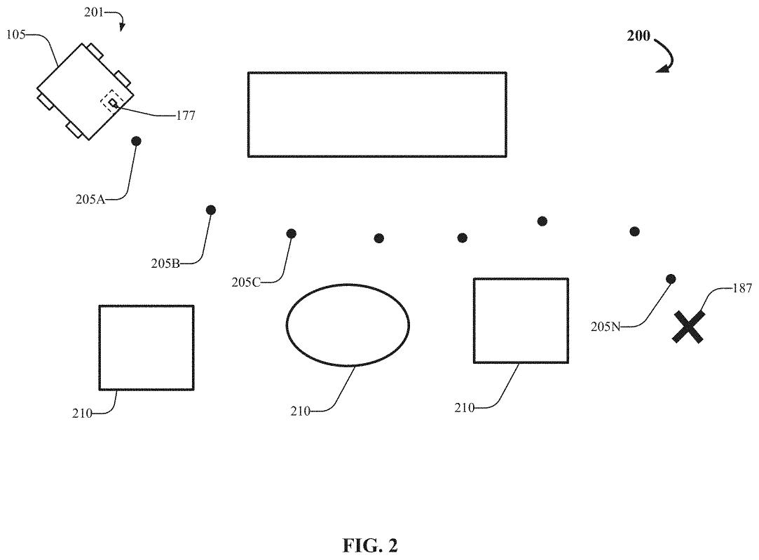

FIG. 2 illustrates an example environment 200 used to train the DRL algorithm in accordance with the present disclosure. The robotic vehicle 105 is depicted in FIG. 1 following a path comprising a plurality of waypoints 205A, 205B, 205C, . . . 205N to a destination goal point 187.

A high-level path-planner may obtain a set of intermediate waypoints 205A-205N from a path planning engine (such as A-Star or similar path planning engine) on a global map that connects a starting point 201 and the destination goal point 187. It should be appreciated that the number of intermediate waypoints 205 that the high-level planner provides is typically only a handful, say 1-10. It should be appreciated that the A-Star algorithm discretizes the continuous path into a much larger number of waypoints, 100-200 in our environment, out of which a smaller equidistant subset, 1-10 is chosen. The DRL policy is then learnt to provide optimal control commands: LEFT, STRAIGHT, or RIGHT, to navigate these waypoints 205, given the sensor data from the camera 177 disposed on a forward-facing portion of the robotic vehicle 105. The LEFT and RIGHT control commands may turn the robot by 10 degrees toward a respective direction, whereas the STRAIGHT is a command to move the robot a predetermined distance (e.g., 0.25 m) forward. This is the discretization of control for experiments described in the present disclosure. It should be appreciated that the learnt policy could alternatively be trained to output continuous velocity commands, like linear and angular velocities.

DRL based training typically requires a substantial volume of data, where the robotic vehicle is trained in simulation across a large number (e.g., 5, 10, 20, 50, etc.) of episodes, where each episode involves randomly chosen start and goal/target locations, while navigating to the destination point 187 through a plurality of obstacles 210. The start and destination points 201, 187 are fixed for the episode, but may vary at the start of the next episode.

Embodiments of the present disclosure describe experiments demonstrating that 150,000 episodes may be completed during a training session, which may utilize computing time of about ˜240 GPU hours (or 10 days) to train the agent. Each training episode may include multiple time step, and the robotic vehicle 105 may be tasked to achieve its episodic goal within a pre-defined maximum number of time steps per episode (empirically determined to be 500).

Present embodiments use deep reinforcement learning (DRL) algorithms and use one or more path planning approaches to create a path using a deep learning approach using reinforcement learning algorithms, trained using traditional learning algorithms such as A-Star.

The DRL robot training system 107 may utilize a DRL based methodology for the robotic vehicle 105, which may be equipped with the RGB and depth camera(s) 177 to navigate map-free indoor environment 200. Given random start and target positions in an indoor environment, the robotic vehicle 105 is tasked to navigate from the start 201 to the destination point 187 without colliding with the obstacles 210.

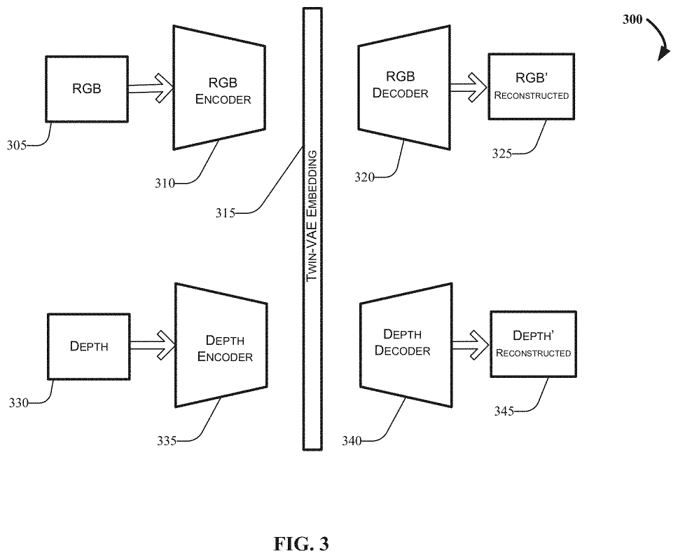

In one embodiment, the DRL robot training system 107 utilizes a pre-trained perception pipeline (a twin Variational Auto-Encoder or VAE depicted in FIG. 3) that learns a compact visual embedding at each position in the environment in simulation. In some aspects, the DRL robot training system 107 may utilize A-Star or another a traditional path-planning algorithm to increase the speed of the training process. It should be appreciated that reference to A-Star waypoints, or utilization of A-Star as a path planning platform may be substituted with another similar path planning engine.

The DRL policy is curriculum-trained using a sequentially increasing spacing of A-Star waypoints (from which the waypoints 205 are selected) between the start point 201 and the destination point 187. The DRL robot training system 107 may increase waypoint spacing as training progresses, representing increasing difficulty of the navigation task. Once the DRL robot training system 107 trains the DRL, the DRL can generate a policy that is able to navigate the robotic vehicle 105 between any arbitrary start and goal locations.

The A-Star algorithm typically uses a top-down map of the environment and the start and goal locations, as illustrated in FIG. 2, to generate a series of waypoints. From the A-Star waypoints, the system may select a subset of waypoints We will use the notation WP1, WP2, WP3, WPN to represent each of the N intermediate waypoints (typically 1-10 waypoints 205). The DRL robot training system 107 may represent the start 201 and destination point 187 locations with S and T, respectively, and so the order of the points the robot has to navigate is S to WP1 205A to WP2 205B to WP3 205C . . . to WPN 205N to T (the destination point 187).

When the robotic vehicle 105 is localized at the start location, S 201, at the beginning of an episode, the robot vehicle 105 is programmed and/or configured for achieving an immediate goal to navigate to WP1 205A. This DRL policy is used to navigate to WP1 with the three control commands as aforementioned: LEFT, STRAIGHT, RIGHT. The DRL robot training system 107 may utilize a Proximal Policy Optimization (PPO) algorithm with the DRL navigation policy being represented by a neural network with two hidden layers, and a Long Short Term Memory (LSTM) for temporal recurrent information.

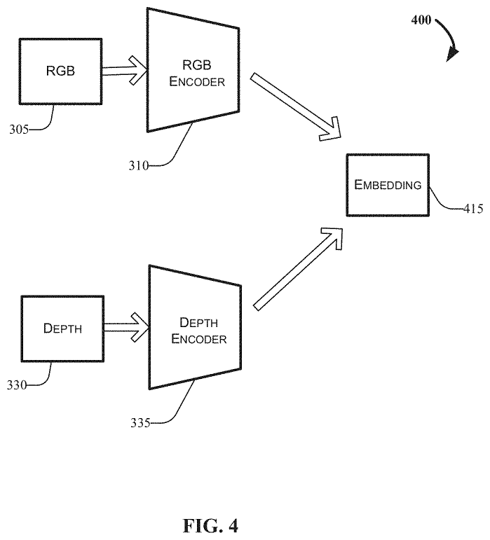

FIG. 3 depicts a twin variational autoencoder (VAE) 300 for learning visual embeddings in accordance with the present disclosure. FIG. 4 depicts a flow diagram 400 for generating an embedding 415 using the twin VAE embedding output (reconstructed RGB image data 325 and reconstructed depth image data 345 of FIG. 3), in accordance with the present disclosure. The flow diagrams of FIG. 3 and FIG. 4 together illustrate an overview of steps used in training the DRL algorithm.

With reference first to FIG. 3, the RGB and depth image camera(s) 177 disposed on a front-facing portion of the robotic vehicle 105 may generate RGB image data 305 and image depth data 330. The DRL robot training system 107 may encode the RGB image data 305 using an RGB encoder 310, encode the image depth data 330 with a depth encoder 335 for a twin VAE embedding process 315. The system may learn visual embeddings for the environment by decoding the RGB image data 305 and the image depth data 330 using an RGB decoder 320 and depth decoder 340, and generate reconstructed RGB image data (RGB′) 325 and a reconstructed depth image data (DEPTH′) 345.

As illustrated in the flow diagram 400 of FIG. 4, the DRL robot training system 107 may process the RGB image data 305 and Image depth data 330 through a pre-trained twin Variational Autoencoder (VAE) comprising the RGB encoder 310 and the depth encoder 335, which provides a compact representation of the environment as one-dimensional vectors (e.g., the RGB′ 325 and the DEPTH′ 345, as shown in FIG. 3). This is termed “Representation Learning” in Deep Learning parlance.

The RGB image is encoded to a one-dimensional representation zRGB, and the Depth encoded to zDepth. In addition, the Euclidean distance d between the current and target (goal) locations are also provided to the DRL during training. Accordingly, the DRL robot training system 107 may supplement the embedding 415 with a distance indicative of a travel distance from its current position (e.g., a waypoint position expressed as cartesian coordinates in the map) and target/goal location 201/187, which the DRL robot training system 107 may utilize to train the agent.

With reference again to FIG. 2, the DRL robot training system 107 may train the DRL using a known reward function configured to reward the robotic vehicle 105 based on its change in instantaneous distance to the current goal (in this case, WP1 205A) between adjacent time steps. Thus, the robotic vehicle 105 may learn to navigate to the current goal location, WP1. Once the robotic vehicle 105 reaches WP1 to within a threshold distance (e.g., 0.2 m), the DRL algorithm, the DRL robot training system 107 gives a bonus reward, and the goal is set to WP2. The DRL robot training system 107 may repeat this same procedure until WP2 205B is reached, after which the robotic vehicle 105 aims to reach WP3 205C, all the way until the final target T (the destination point 187) is reached by the robotic vehicle 105.

The DRL robot training system 107 may next concatenate respective zDepth and zRGB to obtain a state vector for a current pose of the robotic vehicle 105 with respect to the target (e.g., the destination point 187), and utilize the concatenated data in the training of the DRL agent for operation of the robotic vehicle 105.

FIG. 5 illustrates an example schematic 500 for a DRL setup in accordance with the present disclosure. The DRL robot training system 107 may concatenate the encoded RGB data 305 and image depth data 330 received from the RGB encoder 310 and 335, respectively, to obtain a state vector (zRGB, zDepth, d), where d is the distance to the goal point, for the current pose of the robotic vehicle 305 with respect to the destination point 187. The DRL robot training system 107 may use this in the training of the DRL agent 530. The DRL robot training system 107 may utilize the embedding 415 as input for the trained DRL agent 530. The robotic vehicle 105 may choose actions 535 in the operation environment 540 using the DRL agent 530, based on DRL agent policies, and provide feedback RGB image data 305 and image depth data 330 to the RGB encoder 310 and depth encoder 335, respectively, during each training episode.

The training of the agent is undertaken using Curriculum Learning. In Curriculum Learning, the agent is trained on relatively easier tasks during the first training episodes. Once this easier task is learned, the level of difficulty is subsequently increased in small increments, akin to a student's curriculum, all the way until the level of difficulty of the task is equal to what is desired.

According to one or more embodiments, two methodologies of curriculum-based training of the DRL agents are utilized using the method described above: (1) a sequential waypoint method, and (2) a farther waypoint method.

In the sequential waypoint method, the DRL robot training system 107 may use 10 intermediate way points (N=10) for a first training episode. Once the agent has successfully learned to navigate from S to T with 10 intermediate waypoints (after a few 1000s of episodes), the DRL robot training system 107 may increase the level of difficulty by using only 8 intermediate waypoints for the next few (e.g., 1000s) of episodes. It should be appreciated that with fewer intermediate waypoints, the distance between two adjacent waypoints is now greater, and so the level of difficulty is enhanced. Subsequently, the DRL robot training system 107 may train with only 6 intermediate waypoints for few 1000s of episodes, then 4, 3, 2, 1, and finally without any intermediate waypoints. Thus, the level of difficulty follows a curriculum, and increases in discrete jumps every few 1000s of episodes. Once the robotic vehicle 105 has completed the full curriculum, it no longer requires the high-level A-Star waypoints, as it can now navigate to the target T without the intermediate waypoints. Thus, at test/deployment stage the robotic vehicle 105 may be able to navigate all the way from start to target without the help of A-Star.

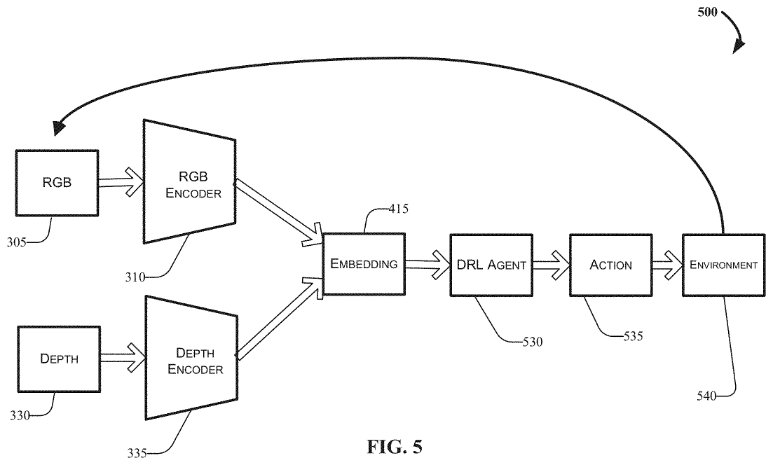

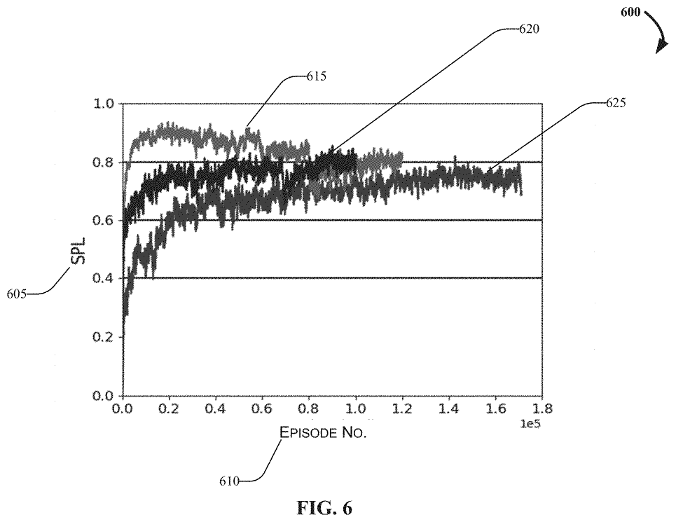

FIG. 6 is a graph illustrating a decrease in training times for learning a navigation pathway from start to end without the system of FIG. 1, compared with training times for the system of FIG. 1, in accordance with the present disclosure. The graph 600 illustrates Success-weighted-Path-Length or SPL 605 (a metric of navigational success) with respect to a number of episodes 610. The SPL metric determines the coincidence between the path output by the DRL algorithm and the optimal path between the start and target locations. In our experiments, the optimal path is given by a simulator (not shown).

Three data results are shown, include results for PointNav 625, where the whole policy is learned from start to end, versus training times for curriculum learning Success Weighted Path (SWP)-10 615, and FWP 620, according to embodiments described herein. The curriculum learning methods SWP-10 615 and Farther WayPoint (FWP) 620 achieved a higher SPL, in half the time, as compared to PointNav 625 results, which is a baseline approach without the A-Star and Curriculum Learning based training speed-ups.

In the farther waypoint method of training, the DRL robot training system 107 may commence with a revised target (T′), which is a small fraction of the total path between S and T. T′ starts off close to S at the first episode of training and is gradually moved closer to T as training progresses. Specifically, T′ is set to be the point corresponding to the 20th percentile of the list of waypoints obtained from A-Star in the first episode. Thus, the robotic vehicle 105 may only needs to learn to navigate 20% of the distance between S and T, after which the vehicle 105 is rewarded, and the episode ends.

For subsequent training episodes, the DRL robot training system 107 may slowly increase the distance of T′ from S in linear increments. At the final training episode, T′ coincides with T, and the robotic vehicle 105 may aim directly for the target T. In experiments, this is done over a span of 100,000 episodes. This is also consistent with Curriculum Learning as the level of difficulty is slowly increased over the training episodes with the agent required to navigate only 20% of the distance from S to T for the first episode, and 100% of the distance by the end of the training (i.e., the last episode). Once trained, the robotic vehicle 105 is deployed, the system 107 may aim only for T and not the intermediate waypoints.

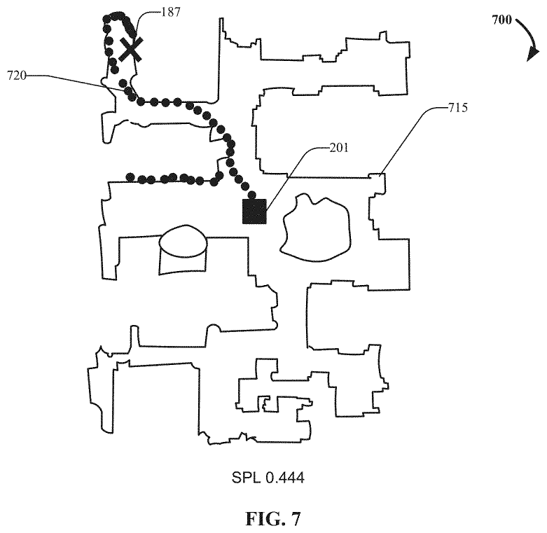

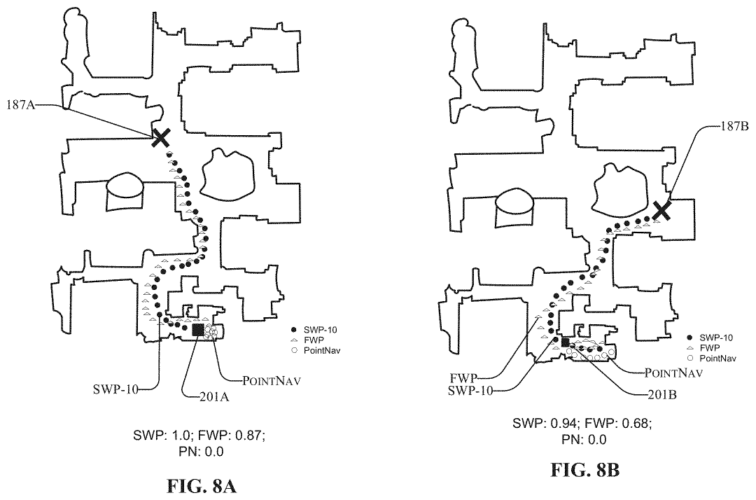

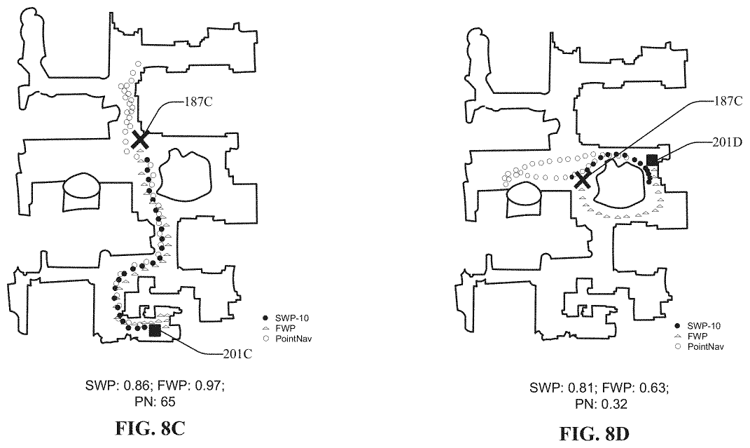

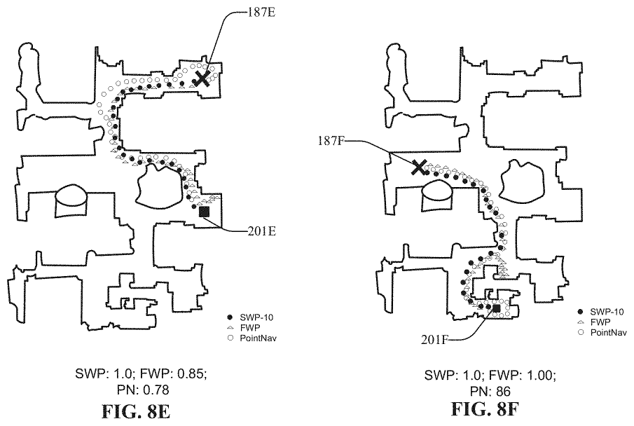

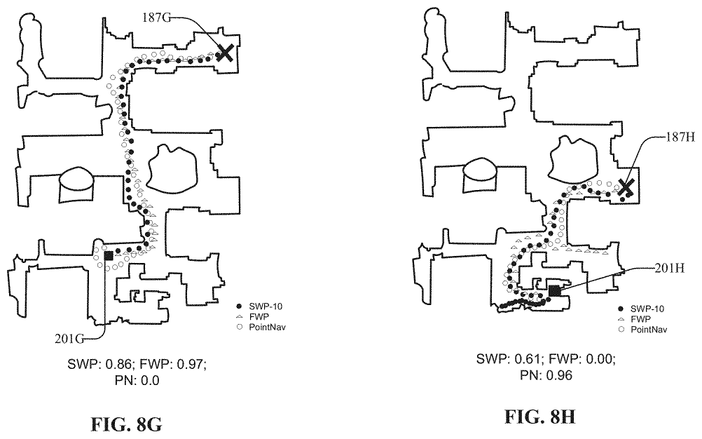

FIG. 7 depicts a demonstration of quality of paths followed using an algorithm trained using the setup of FIG. 5 in accordance with the present disclosure. FIGS. 8A, 8B, 8C, 8D, 8E, 8F, 8G, and 8H depict demonstrations of test time paths followed while training the robotic vehicle 105 of FIG. 1, in accordance with the present disclosure.

With attention first given to FIG. 7, a path 720 is illustrated in a map 715 of the operational training environment. The robotic vehicle 105 is illustrated at a starting point 201, with the travel path connecting the starting position to a destination point 187, including deviations from the optimal pathway connecting those points.

This illustrates an example path taken by the robotic vehicle 105 in a simulation environment during training. SPL (Success weighted Path Length) indicates the level of success in reaching the goal. As the relative success of the navigational path increases, the SPL approaches a value of 1. As shown in FIG. 7, the SPL of 0.444 indicates intermediate quality output by the algorithm during training.

FIGS. 8A-8H shows paths after training the algorithm completely and contrasts the baseline approach (PointNav) vs our curriculum based improvements (SWP, FWP) in training. Test time paths traced by the PointNav system (e.g., A-Star) shown as empty circles, SWP-10 (shown as solid circles), and FWP shown as triangles, in a bird's eye view representation of the environment for respective episodes. The start point 201N, and the destination point 187N positions are shown in each respect FIG.

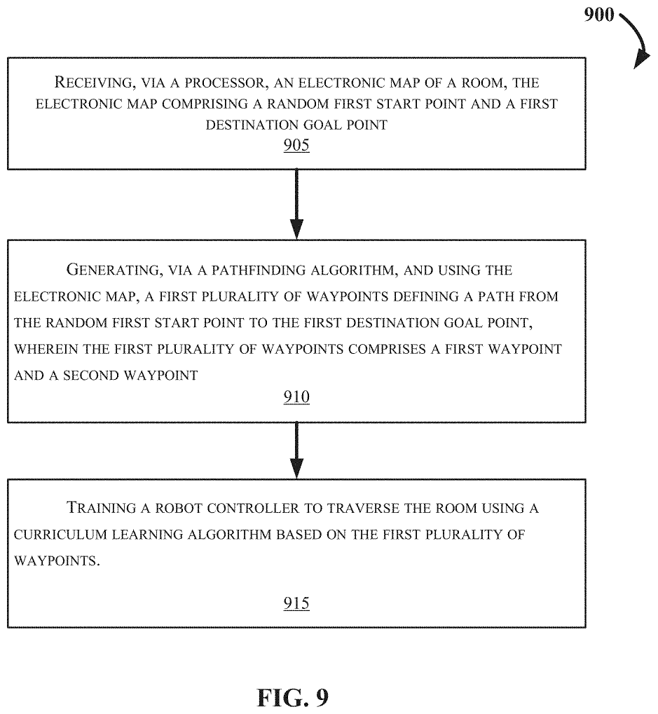

FIG. 9 is a flow diagram of an example method 900 for training a robot controller, according to the present disclosure. FIG. 9 may be described with continued reference to prior figures, including FIGS. 1-6. The following process is exemplary and not confined to the steps described hereafter. Moreover, alternative embodiments may include more or less steps that are shown or described herein, and may include these steps in a different order than the order described in the following example embodiments.

Referring first to FIG. 9, at step 905, the method 900 may commence with receiving, via a processor, an electronic map of a room, the electronic map comprising a random first start point and a first destination goal point.

At step 910, the method 900 may further include generating, via a pathfinding algorithm, and using the electronic map, a first plurality of waypoints defining a path from the random first start point to the first destination goal point, wherein the first plurality of waypoints comprises a first waypoint and a second waypoint. According to one embodiment, the pathfinding algorithm is A-Star.

This step may include generating, with the pathfinding algorithm, a first set of waypoints connecting the start point and the first destination goal point, and selecting, from the first set of waypoints, the first plurality of waypoints. In one aspect, the first plurality of waypoints are equidistant from one another.

According to another embodiment, first plurality of waypoints includes a maximum of 10 waypoints.

Generating the first plurality of waypoints may further include generating the first waypoint with the pathfinding algorithm, generating the second waypoint with the pathfinding algorithm, where the second waypoint is contiguous to the first waypoint, and connecting the second waypoint to a third waypoint contiguous to the second waypoint and closer to the first destination goal point.

At step 915, the method 900 may further include training a robot controller to traverse the room using a curriculum learning algorithm based on the first plurality of waypoints. This step may include navigating from the first waypoint to the second waypoint using three control commands that can include left, straight, and right. The step may further include generating a red-green-blue (RGB) image and a depth image, encoding the RGB image and the depth image through an embedding, and supplementing the embedding with a distance between a current position and the first destination goal point.

According to another aspect of the present disclosure, this step may further include rewarding, with a reward function, the curriculum learning algorithm with a bonus reward responsive reaching a position less than a threshold distance from a subsequent waypoint.

This step may further include loading a pre-trained perception pipeline, and defining, using the curriculum learning algorithm, a compact visual embedding at each waypoint of the first plurality of waypoints, determining that the vehicle has reached the first destination goal point, selecting a second random destination goal point that is different from the first destination goal point, and selecting a second plurality of waypoints having fewer waypoints than the first plurality of waypoints.

According to another aspect of the present disclosure, this step may include determining that the vehicle has reached the first random destination goal point, selecting a second random start point having a distance to a second destination goal point that is a threshold distance further to the second random start point than a distance from the first start point and the first destination goal point, and selecting a third plurality of waypoints connecting the second destination goal point and the second random start point. The system may reward the curriculum learning algorithm with a bonus reward responsive reaching a position less than a threshold distance from a subsequent waypoint.

Aspects of the present disclosure use curriculum-based training approaches to train Deep Reinforcement Learning (DRL) agents to navigate indoor environments. A high-level path planning algorithm (A-Star, for example) is used to assist the training of a low-level policy learned using DRL. Once the DRL policy is trained, the robotic vehicle uses only the current image from its RGBD camera, and its current and goal locations to generate navigation commands to successfully find its way to the goal. The training system accelerates the DRL training by pre-learning a compact representation of the camera data (RGB and depth images) throughout the environment. In addition, the A-Star based supervision with curriculum-based learning also decreases the training time by at least a factor of 2 and with a further improvement in performance (measured by SPL).

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method for controlling a vehicle, comprising:
receiving, via a processor, an electronic map of a room, the electronic map comprising a random first start point and a first destination goal point;
generating, via a pathfinding algorithm, and using the electronic map, a first plurality of waypoints defining a path from the random first start point to the first destination goal point, wherein the first plurality of waypoints comprises a first waypoint and a second waypoint; and
training a robot controller to traverse the room using a curriculum learning algorithm based on the first plurality of waypoints.

2. The method according to claim 1, wherein generating the first plurality of waypoints comprises:
generating, with the pathfinding algorithm, a first set of waypoints connecting the start point and the first destination goal point; and
selecting, from the first set of waypoints, the first plurality of waypoints, wherein the first plurality of waypoints are equidistant.

3. The method according to claim 2, wherein the first plurality of waypoints comprises a maximum of 10 waypoints.

4. The method according to claim 1, wherein the pathfinding algorithm is A-Star.

5. The method according to claim 1, wherein creating the first plurality of waypoints comprises:
generating the first waypoint with the pathfinding algorithm;
generating the second waypoint with the pathfinding algorithm, wherein the second waypoint is contiguous to the first waypoint; and
connecting the second waypoint to a third waypoint contiguous to the second waypoint and closer to the first destination goal point.

6. The method according to claim 1, wherein training the robot controller to traverse the room using the curriculum learning algorithm comprises:
navigating from the first waypoint to the second waypoint using three control commands comprising left, straight, and right;
generating a red-green-blue (RGB) image and a depth image;
encoding the RGB image and the depth image through an embedding; and
supplementing the embedding with a distance between a current position and the first destination goal point.

7. The method according to claim 6, wherein training the robot controller to traverse the room using the curriculum learning algorithm further comprises:
rewarding, with a reward function, the curriculum learning algorithm with a bonus reward responsive reaching a position less than a threshold distance from a subsequent waypoint.

8. The method according to claim 1, wherein training the robot controller comprises:
loading a pre-trained perception pipeline; and
defining, using the curriculum learning algorithm, a compact visual embedding at each waypoint of the first plurality of waypoints.

9. The method according to claim 1, wherein training the robot controller to traverse the room using the curriculum learning algorithm comprises:
determining that the vehicle has reached the first destination goal point;
selecting a second random destination goal point that is different from the first destination goal point; and
selecting a second plurality of waypoints having fewer waypoints than the first plurality of waypoints.

10. The method according to claim 1, wherein training the robot controller to traverse the room using the curriculum learning algorithm comprises:
determining that the vehicle has reached the first destination goal point;
selecting a second random start point having a distance to a second destination goal point that is a threshold distance further to the second random start point than a distance from the first start point and the first destination goal point; and a
selecting a third plurality of waypoints connecting the second destination goal point and the second random start point.

11. A system, comprising:
a processor; and
a memory for storing executable instructions, the processor programmed to execute the instructions to:
receive an electronic map of a room, the electronic map comprising a random first start point and a first destination goal point;
generate, via a pathfinding algorithm, and using the electronic map, a first plurality of waypoints defining a path from the random first start point to the first destination goal point, wherein the first plurality of waypoints comprises a first waypoint and a second waypoint; and
train a robot controller to traverse the room using a curriculum learning algorithm based on the first plurality of waypoints.

12. The system according to claim 11, wherein the processor is further programmed to generating the first plurality of waypoints by executing the instructions to:
generate, with the pathfinding algorithm, a first set of waypoints connecting the start point and the first destination goal point; and
select, from the first set of waypoints, the first plurality of waypoints, wherein the first plurality of waypoints are equidistant.

13. The system according to claim 12, wherein the first plurality of waypoints comprises a maximum of 10 waypoints.

14. The system according to claim 11, wherein the pathfinding algorithm is A-Star.

15. The system according to claim 11, wherein the processor is further programmed to creating the first plurality of waypoints by executing the instructions to:
generate the first waypoint with the pathfinding algorithm;
generate the second waypoint with the pathfinding algorithm, wherein the second waypoint is contiguous to the first waypoint; and
connect the second waypoint to a third waypoint contiguous to the second waypoint and closer to the first destination goal point.

16. The system according to claim 11, wherein the processor is further programmed to train the robot controller to traverse the room using the curriculum learning algorithm by executing the instructions to:
navigate from the first waypoint to the second waypoint using three control commands comprising left, straight, and right;
generate a red-green-blue (RGB) image and a depth image;
encode the RGB image and the depth image through an embedding; and
supplement the embedding with a distance between a current position and the first destination goal point.

17. The system according to claim 16, wherein the processor is further programmed to train the robot controller to traverse the room using the curriculum learning algorithm by executing the instructions to:
reward, with a reward function, the curriculum learning algorithm with a bonus reward responsive reaching a position less than a threshold distance from a subsequent waypoint.

18. The system according to claim 11, wherein the processor is further programmed to train the robot controller by executing the instructions to:
load a pre-trained perception pipeline; and
define, using the curriculum learning algorithm, a compact visual embedding at each waypoint of the first plurality of waypoints.

19. The system according to claim 11, wherein the processor is further programmed to train the robot controller by executing the instructions to:
determine that the robotic robot controller has caused a robotic vehicle to reach the first destination goal point;
select a second random destination goal point that is different from the first destination goal point; and
select a second plurality of waypoints having fewer waypoints than the first plurality of waypoints.

20. A non-transitory computer-readable storage medium having instructions stored thereupon which, when executed by a processor, cause the processor to:
receive an electronic map of a room, the electronic map comprising a random first start point and a first destination goal point;
generate, via a pathfinding algorithm, and using the electronic map, a first plurality of waypoints defining a path from the random first start point to the first destination goal point, wherein the first plurality of waypoints comprises a first waypoint and a second waypoint; and
train a robot controller to traverse the room using a curriculum learning algorithm based on the first plurality of waypoints.
